(19) United States
(12) Patent Application Publication
(10) Pub. No.: US 2026/0234950 A1
(43) Pub. Date: Aug. 13, 2026

(54) RETAINER ARRANGEMENT, LENGTH-ADJUSTBLE STRUT AND ASSEMBLY THEREOF

(71) Applicant: HOLMATRO B.V., VL RAAMSDONKSVEER (NL)

(72) Inventors: René Wilhelmus Johannes VAN EINDHOVEN, VL RAAMSDONKSVEER (NL); Roelof Richard SCHIPPER, VL RAAMSDONKSVEER (NL)

(21) Appl. No.: 19/153,227

(22) PCT Filed: Feb. 5, 2024
(86) PCT No.: PCT/NL2024/050057

§ 371 Date: Aug. 1, 2025

(30) Foreign Application Priority Data
Feb. 3, 2023 (NL) 2034087

(51) Int. Cl. E04G 25/06; A62B 3/00; E02D 17/08; E04G 23/04; E04G 25/04

(52) U.S. Cl. CPC E04G 25/065; A62B 3/005; E04G 23/04; E02D 17/083; E04G 2025/042

(57) ABSTRACT

A retainer arrangement is adapted for a length-adjustable strut having an inner elongate member extending in an axial direction and having an outer thread, an outer elongate member in which the inner elongate member is slidably arranged to slide along the axial direction, and a nut element rotatably arranged over the inner elongate member and provided with an inner thread configured to engage the outer thread of the inner elongate member. The retainer arrangement, a length-adjustable strut adapted for such retainer arrangement, and a strut assembly, includes at least one bracket configured to releasably couple the nut element and the outer elongate member to prevent outward sliding of the inner elongate member relative to the outer elongate member.

The present invention relates to a retainer arrangement for a length-adjustable strut and said length-adjustable strut. The invention further relates to an assembly of such retainer arrangement with a length-adjustable strut and methods of using such assembly.

A strut is a tool or assembly configured to temporarily support an unstable load, for instance a vehicle, a building, a tree, an elevator and the like. A strut usually comprises one or more elongate member configured to be extendable in an axial direction for varying the length of the strut. A strut may define a spacer and can be used in many applications, in particular in shoring applications. In this respect, shoring is defined as providing a temporary support to an instable load. Shoring normally involves securing a risky situation and providing rescue workers, such as firemen, temporarily the safest possible working conditions. Such shoring applications may be very diverse, such as trench shoring, providing support against structural collapse of e.g. a building, and vehicle stabilization and lifting, in particular after a crash.

Apart from the great variety of applications wherein struts are used, struts may be distinguished by other factors. For instance, the maximum length of the strut may differ, from as small as 0.2 m up to 5 m. In order to be able to handle most situations, safety and rescue workers are often required to possess and maintain a large variety of different struts and strut components, and take them to rescue sites. Although they may be extendable and selectively connectable to accessories and/or to each other, a selection of multiple struts in differing lengths will also require considerable space in the vehicle of the safety and rescue workers. Moreover, such components need to be strong and therefore are heavy as well. In view of space and weight considerations, often only a selection of struts and strut components are taken to a site, this sometimes leading to a sub optimal solution if the situation on-site differs from the expectations. Struts can for example be configured for spot shoring, raker constructions and other rescue situations.

A strut can be defined as a tool comprising an outer tube and an inner tube slidably arranged in the outer tube so that a length of the strut can be set to support an unstable load by bridging a certain space. The strut may thus be length-adjustable and may thus define a length-adjustable spacer. In order to support such load while maintaining said space, struts generally further comprise means for preventing inward sliding of the inner tube into the outer tube once a length of the strut has been set. Further, each end of the strut may have a coupling piece and/or accessory to engage with the objects at either end, e.g. the load at an upper end and a ground surface at a lower end.

Various struts are currently available. These can be categorised into mechanical, electrical, hydraulic and pneumatic struts. Further, a maximum and/or minimum strut length may vary, for example in relation to intended applications. For most practical applications, struts have to bridge space of between 0.2 m and 5 m and thus have to be able to reach such lengths, possibly with the aid of auxiliary tubes for additional lengthening of the strut beyond its own maximum length. Rescue workers in particular are expected to work effectively in a great variety of situations and therefore currently often carry a large set of struts, to which are added various auxiliary tubes and accessories. A variety of applications can be constructed from such equipment, ranging from a simple spot shore to an elaborate raker construction.

It is preferred that a support for an unstable load is arranged on location as quickly as possible. This is to limit the time during which rescue workers are exposed to dangerous situations such as structural collapse. Moreover, the support is generally positioned to safeguard people, e.g. victims of accidents or natural disasters, who may need to be extracted from a dangerous location as quickly as possible. The sooner a support system is in place, the sooner rescue workers can proceed to aid and/or remove such victim. In such situations, every second matters.

For time saving reasons, the most advanced struts presently on the market are designed to be adjustable in length with an outer tube in which an inner tube is arranged to be manually or pneumatically extended from the inner tube in a linear way. The inner tube is provided with a thread (i.e. screw thread) on its exterior. A nut is arranged over the inner tube and can be moved manually over the thread of the inner tube (i.e. by turning or screwing the nut) to abut the nut against the outer tube from which the inner tube extends so as to provide a mechanical lock. This locking mechanism serves to withstand substantial compressive forces experienced by the strut over its length and thereby prevents inward sliding of the inner tube, i.e. shortening of the strut.

However, struts with the above construction are not capable of withstanding tensile forces along its length, i.e. prevent elongation of the strut. In a range of strut applications, it would be advantageous to prevent elongation of the strut, even in addition to preventing shortening. In this context, the example of a raker construction is presented. A raker construction can be assembled of struts and corresponding accessories to support an unstable wall or other upright objects to prevent a building from (further) collapsing. In such raker construction, the main load-bearing elements are diagonal struts, variable in length up to over 5 m. The load-bearing capacity of such longs struts is primarily limited by the mechanical phenomenon of buckling. To prevent buckling of the load-bearing struts in the raker construction or other application, diagonal ribs are used, known as braces, which have to withstand both compressive as well as tensile forces along their length. Known struts cannot be employed as braces since these are unable to withstand tensile forces.

Braces are customarily implemented as an outer tube having in internal screw thread and an inner tube having an external screw thread configured to engage that of the outer tube. Such a brace can be set to the appropriate length by manually rotating or screwing the whole inner tube relative to the outer tube. This takes time and effort, especially when done manually as is usually the case in rescue operations. Such braces cannot be extended by remotely controlled pneumatics. Functionality of struts and braces have therefore diverged in the field of rescue operations as these perform different, complementary functions while each have their limitations. This necessitates rescue worker to have at their disposal various braces for use with an array of struts as described above, and to have them ready in their standard equipment, e.g. loaded on a rescue boat or truck. Rescue teams therefore usually take an array of equipment along with them to their next rescue operation even while most of these items may turn out to be superfluous or not useful once on site.

A further disadvantage of the current strut models as described above is that the nut, even when tightened onto the outer tube, can loosen or release itself from the outer tube and rotate over the thread of the inner tube. This can be caused by vibrations such as an aftershock in rescue operations following an earthquake or by shifting of the unstable load supported by the strut. Other causes of nut loosening can involve unintended contact with the nut, for example when rescue workers apply struts in spot shoring. In such situations, struts may be used to provide access to tight spaces, for example in a collapsed or structurally unstable building, to provide access to any victims. Rescue workers then work in close proximity to these spot-shoring struts and therefore risk unintentionally unscrewing a nut of a strut. When the nut is somehow loosened, the mechanical lock of the strut against inward sliding of the inner tube relative to the outer tube is released, the strut shortens and may thereby lose its supporting function or even drop out of the space it has to bridge. This poses a severe hazard to rescue workers and the victims they intend to rescue or extract.

It is an object of the present invention to overcome or at least reduce disadvantageous of existing length-adjustable struts.

This object is achieved by providing a retainer arrangement as defined in claim 1.

The retainer arrangement prevents outward sliding of the inner elongate member relative to the outer elongate member by coupling the nut element of the length-adjustable strut with the outer elongate member of the length-adjustable strut. Length-adjusting of the strut is again possible when the retainer arrangement is released. The retainer arrangement ensures the elongation of the strut can be prevented and enables use of struts as braces in e.g. raker constructions, thus rendering braces obsolete and reducing the number of components rescue workers need to bring on site.

The retainer arrangement can be provided as a separate device or may be integrated with the length-adjustable strut. In each case, the invention allows rapid conversion of a length-adjustable strut having the capacity to withstand compressive forces along its axial direction into a brace having the capacity to withstand both compressive as well as tensile forces along its axial direction. Moreover, when the retainer arrangement is coupling the nut element and the outer elongate member of the length-adjustable strut, said strut is prevented from losing its stabilizing function caused by loosening of the nut due to, for example, shocks or unintended contact.

The invention further provides a length-adjustable strut as defined in claim 22. This strut is specifically adapted to be releasably coupled by the retainer arrangement according to the invention. The retainer arrangement and the length-adjustable strut form two interrelated products.

The invention further provides a strut assembly as defined in claim 34. Said assembly comprises a retainer arrangement arranged or arrangeable on a length-adjustable strut according to the invention. The retainer arrangement can be provided separately from the length-adjustable strut or may be arranged on it.

Preferred embodiments are the subject of dependent claims and the following description.

The retainer arrangement is adapted for a length-adjustable strut, said strut having an inner elongate member extending in an axial direction and having an outer thread, an outer elongate member in which the inner elongate member is slidably arranged to slide along the axial direction, and a nut element rotatably arranged over the inner elongate member and provided with an inner thread configured to engage the outer thread of the inner elongate member. The retainer arrangement comprises at least one bracket configured to releasably couple the nut element and the outer elongate member to prevent outward sliding of the inner elongate member relative to the outer elongate member. Extension or elongation of the length-adjustable strut can be prevented when such retainer arrangement is coupling the nut element to the outer elongate member.

The term retainer or retaining may refer to lock or locking. The retainer arrangement may form a lock arrangement adapted for locking a length-adjustable strut, in particular locking against elongation of the strut.

The sliding of the inner outer elongate member relative to the outer elongate member may only be in the axial direction, i.e. not involving in a tangential or rotational direction which could unscrew the inner elongate member through the nut. Sliding along the axial direction refers to both elongation and shortening of the length-adjustable strut as the inner elongate member slides outward or inward, respectively, relative to the outer elongate member.

The nut element may take various forms (e.g. flat or elongate along the axial direction relative to a radial direction). For example, the nut element may be provided in the form of a conventional nut suitable for the purpose of having an inner thread corresponding to the outer thread of the inner elongate member. An exterior surface of the nut element may be configured to be engaged by a tool, such as a wrench, or a tool, preferably a multipurpose rescue tool, adapted to cooperate with the exterior surface of the nut element. As in conventional nuts, the inner thread of the nut element may in particular be arranged at an interior surface of a through hole or bore, which may extend through the nut element in the axial direction when mounted to the inner elongate member of the strut.

In an embodiment, the at least one bracket is further configured to releasably couple the nut element and the outer elongate member to prevent rotation of the nut element over the inner elongate member. This can prevent accidental loosening of the nut (e.g. by shocks, unintended contact, shifting of load). When the nut loosens, the length-adjustable strut may get shorter. The bracket may advantageously prevent shortening of the strut as well as elongation.

In an embodiment, the retainer arrangement is configured to, in a retaining state in which the at least one bracket is coupled to the nut element and to the outer elongate member, prevent outward sliding of the inner elongate member relative to the outer elongate member, and to, in a releasing state in which the at least one bracket is not coupled to (e.g. released from) at least one of the nut element and the outer elongate member, allow outward sliding of the inner elongate member relative to the outer elongate member. In the retaining state, the nut element may contact the outer elongate member, for example abut against a rim surrounding on opening of the outer elongate member through which the inner elongate member is slidably arranged.

In the releasing state, the at least one bracket may still be coupled to the nut element or to the outer elongate member, in particular in the embodiments where the retainer arrangement is arranged on one of the nut element and the outer elongate member to be releasably coupled to the other of the nut element and the outer elongate member.

Additionally or alternatively, the retainer arrangement may be configured to, in the retaining state, prevent rotation of the nut element over the inner elongate member. As a further additional or alternative feature, the retainer arrangement may be configured to, in the releasing state, allow rotation of the nut element over the inner elongate member.

In an embodiment, the at least one bracket comprises an interior surface shaped to engage an exterior surface portion of the strut, which exterior surface portion comprises at least a portion of the nut element and a portion of the outer elongate member. A fitting and/or matching shape may be sufficient to clamp the nut element relative to the outer elongate member. The interior surface of the bracket may comprise the first and/or second interior coupling elements described below.

In an embodiment, the at least one bracket is configured to embrace the nut element along the axial direction. In other words, the bracket may extend in the axial direction over the nut element. For example, the bracket may comprise a bridge portion extending in the axial direction, when arranged on the strut, between a first axial end configured to engage the nut element and a second axial end configured to engage the outer elongate member.

In an embodiment, the at least one bracket comprises a first interior coupling element configured to releasably engage a first exterior coupling element of the nut element.

In an embodiment, the first interior coupling element comprises a protrusion or recess configured to releasably engage an associated recess or protrusion, respectively, comprised by the first exterior coupling element.

The first interior coupling element may comprise a protrusion having an abutment surface configured to engage an edge and/or top surface of the nut element distant from the outer elongate member along the axial direction. In this way, the at least one bracket may be configured to embrace the nut along the axial direction and releasably engage the nut at its top edge or surface facing away from the outer elongate member.

In an embodiment, the at least one bracket comprises a second interior coupling element configured to releasably engage a second exterior coupling element of the outer elongate member. This second exterior coupling element is preferably arranged at or near an end of the outer elongate member at which the nut element is positioned when tightened onto the outer elongate member.

The second interior coupling element may comprise a protrusion or recess configured to releasably engage an associated recess or protrusion, respectively, comprised by the second exterior coupling element.

The interior surface of the bracket may comprises the first interior coupling element and/or the second interior coupling element.

In an embodiment, the at least one bracket comprises the first interior coupling element arranged at a first axial end of the bracket configured to be releasably coupled to the nut element and/or the second interior coupling element arranged at a second axial end of the bracket configured to be releasably coupled to the outer elongate member.

When only one of the first or second interior coupling element is provided, the bracket is preferrable coupled to the outer elongate member or to the nut element, respectively. The retainer arrangement may thus comprise said outer elongate member or said nut, or may in fact be comprised by the length-adjustable strut. When both the first and second interior coupling elements are provided, the bracket may be provided separate from the length-adjustable strut (or the nut element and/or the outer elongate member thereof) and be releasably arrangeable onto these components.

In an embodiment, the at least one bracket comprises a band guide slot configured to guide the flexible band in a tangential direction relative to the axial direction around the bracket for fastening the at least one bracket to the strut. The bracket may be provided with the flexible band or said band can be provided in retrofit. The bracket may couple to the strut without requiring said band.

The band guide slot may comprise an upper rim and/or a lower rim extending in the tangential direction configured to guide the flexible band therebetween. This arrangement prevents said band from sliding away in the axial direction, in particular upwards and/or downwards, thereby potentially releasing one or more brackets from the strut.

In an embodiment, the retainer arrangement further comprises the flexible band for releasably coupling the at least one bracket to the nut element and/or the outer elongate member of the strut.

The flexible band may comprise a releasable band fastener, preferably a hook-and-loop fastener. Other examples of releasably coupling with a flexible band include use of a cable tie, buttons, hook-and-eye, releasable glue and knotting the ends of the flexible band. It is preferred that a releasable coupling is made which allows quick fastening of the flexible band when installing the retainer arrangement and quick release when removing the retainer arrangement for minimal dwelling time of rescue workers in hazardous situations.

In an embodiment, the at least one bracket comprises two brackets. In other words, the retainer arrangement may include more than two brackets, or exactly two of such brackets. Two brackets can be mutually coupled in various ways, for example by means of pivot connection, a flexible band, magnetic elements, snap locks, mutually engaging protrusions and recesses, and combinations thereof.

In an embodiment, the retainer arrangement further comprises a pivot connecting two brackets at a first tangential position. Tangential is seen relative to the axial direction as defined by the strut to which the retainer arrangement is couplable or coupled.

In an embodiment, the retainer arrangement further comprises a closure device to releasably couple two brackets at a second tangential position. The closure device may be implemented as a bolt with associated nut, a snap lock, a magnetic element and may even be formed by the flexible band.

In an embodiment, the at least one bracket comprises one of the first interior coupling element and the second interior coupling element configured to releasably engage one of the nut element and the outer elongate member, respectively, and a pivot couplable to the other of the nut element and the outer elongate member. The pivot may even be coupled to the other of the nut element and the outer elongate member, rather than merely being couplable to it, when the retainer element is comprised by the strut or a component thereof, in particular the nut element or the outer elongate member.

In an embodiment, the at least one bracket comprises a biased lever pivotably couplable to one of the nut element and the outer elongate member and releasably couplable to the other of the nut element and the outer elongate member. Such lever may be biased by a biassing means such as a spring element to engage the other of the nut or the elongate member while being pivotally coupled to the one of the nut or the elongate member. The biassing means or spring element may be the closure device.

The length-adjustable strut of the present disclosure has an inner elongate member which extends in an axial direction and has an outer thread, an outer elongate member in which the inner elongate member is slidably arranged to slide along the axial direction, and a nut element which is rotatably arranged over the inner elongate member and is provided with an inner thread configured to engage the outer thread of the inner elongate member. The nut element and the outer elongate member are configured to be releasably coupled by a retainer arrangement according to the present disclosure to prevent outward sliding of the inner elongate member relative to the outer elongate member.

It is foreseen to adapt existing length-adjustable struts for releasably coupling to the retainer arrangement of the present disclosure. For example, existing length-adjustable struts can be provided or retro-fitted with the exterior coupling elements or their nut elements can be replaced by a nut element having a retainer arrangement installed thereon. It is also possible to adapt their outer elongate member to have a retainer arrangement thereon.

The length-adjustable strut may be configured to prevent inward sliding of the inner elongate member relative to the outer elongate member when the nut element is tightened over the outer thread of the inner elongate member onto the outer elongate member.

In an embodiment, the nut element and the outer elongate member are configured to be releasably coupled by the retainer arrangement to prevent rotation of the nut element over the inner elongate member.

In an embodiment, an exterior surface portion of the strut comprising at least a portion of the nut element and a portion of the outer elongate member are shaped to engage an interior surface of the at least one bracket; and

In an embodiment, the nut element is configured to be embraced by the bracket along the axial direction.

In an embodiment, the nut element comprises a first exterior coupling element configured to releasably engage a first interior coupling element of the at least one bracket.

The first exterior coupling element may comprise a recess or protrusion configured to releasably engage an associated protrusion or recess, respectively, comprised by the first interior coupling element. Alternatively or additionally, the first exterior coupling element may comprise an edge and/or top surface of the nut element distant from the outer elongate member along the axial direction configured to engage the first interior coupling element comprising a protrusion having an abutment surface configured to engage the edge and/or top surface of the nut element.

In an embodiment, the outer elongate member comprises a second exterior coupling element configured to releasably engage a second interior coupling of the at least one bracket.

The second interior coupling element may comprise a protrusion or recess configured to releasably engage an associated recess or protrusion, respectively, comprised by the second exterior coupling element. Alternatively or additionally, the second exterior coupling element may be arranged at or near an axial end of the outer elongate member into which the inner elongate member is slidably arranged. The strut may comprise a recess, such as a hole or a slot, or a protrusion, such as a rib, an edge, a flange, a nob or a pin, arranged near an end of the outer elongate member facing the nut into which protrusions of the retainer arrangement are arrangeable. Similar recesses or protrusions can be provided with the retainer arrangement.

The second exterior coupling element may be configured to receive a tool for holding the outer elongate member when turning the nut element.

The outer elongate member may comprise an abutment surface facing the nut element and surrounding an opening through which the inner elongate member is slidably arranged.

In an embodiment, the outer elongate member and the inner elongate member comprise guides configured to guide sliding of the inner elongate member through the outer elongate member in the axial direction and prevent rotation about the axial direction. For example, the outer elongate member may comprise a protruding guide which faces the inner elongate member and is configured to slot into a recessed guide comprised by the inner elongate member, or vice versa. Advantages of this arrangement include rapid length adjustment (especially compared to the slowness of screwing) and enhanced prevention of unintended sliding of the inner elongate member relative to the outer elongate member along the axial direction.

It is preferred that the strut is a recue strut.

The strut may further comprise a connector at one or both axial ends of the strut, for example a first connector arranged at an axial end of the outer elongate member and/or a second connector at an axial end of the inner elongate member. One or both axial ends of the strut may be provided with an accessory, preferably coupled to the strut via its connectors.

The strut assembly of the present disclosure comprises a length-adjustable strut as disclosed herein and a retainer arrangement of the present disclosure arranged or arrangeable on said strut. Various embodiments of the retainer arrangement and/or length-adjustable strut are couplable or coupled to each other. In particular, the retainer arrangement is couplable to both the nut element and the outer elongate member while it need only be releasably couplable to only one of the nut element and the outer elongate member. The retainer arrangement may, for example, be fixedly coupled to the other of the nut element and the outer elongate member.

In an embodiment, the strut assembly is configured to:
in a retaining state in which the at least one bracket is coupled to the nut element and to the outer elongate member, prevent outward sliding of the inner elongate member relative to the outer elongate member and preferably also prevent rotation of the nut element over the inner elongate member; and
in a releasing state in which the at least one bracket is not coupled to at least one of the nut element and the outer elongate member, allow outward sliding of the inner elongate member relative to the outer elongate member and preferably also allow rotation of the nut element over the inner elongate member.

A shoring construction or a raker construction is provided which comprises at least one length-adjustable strut assembly as described herein.

The invention further provides a method of shoring and/or supporting an unstable load, which method involves employing a retainer arrangement according to the present disclosure, a length-adjustable strut according to the present disclosure and/or a strut arrangement according to the present disclosure.

In particular, a method of shoring may comprise the steps of:
providing a strut assembly according to the present disclosure;
adjust a length of the length-adjustable strut based on a desired spacing by sliding the inner elongate member relative to the outer elongate member in the axial direction of the length-adjustable strut;
tightening the nut element onto the outer elongate member to prevent inward sliding of the inner elongate member relative to the outer elongate member; and
coupling the retainer arrangement to both the nut element and the outer elongate member of the length-adjustable strut to prevent outward sliding of the inner elongate member relative to the outer elongate member and preferably also prevent rotation of the nut element over the inner elongate member. The strut assembly may be provided with a separate retainer arrangement and length-adjustable strut, or with a length-adjustable strut comprising the retainer arrangement, e.g. by virtue of the retainer arrangement being already arranged on one of the nut element and the outer elongate member.

Finally, the invention provides use of at least one of: a retainer arrangement according to the present disclosure; a length-adjustable strut according to the present disclosure; a strut assembly according to the present disclosure; and/or a shoring or raker construction of the present disclosure, to support an unstable load, preferably in shoring applications, more preferably in rescue operations.

Various exemplary embodiments of the present disclosure are illustrated in the following drawings, in which:

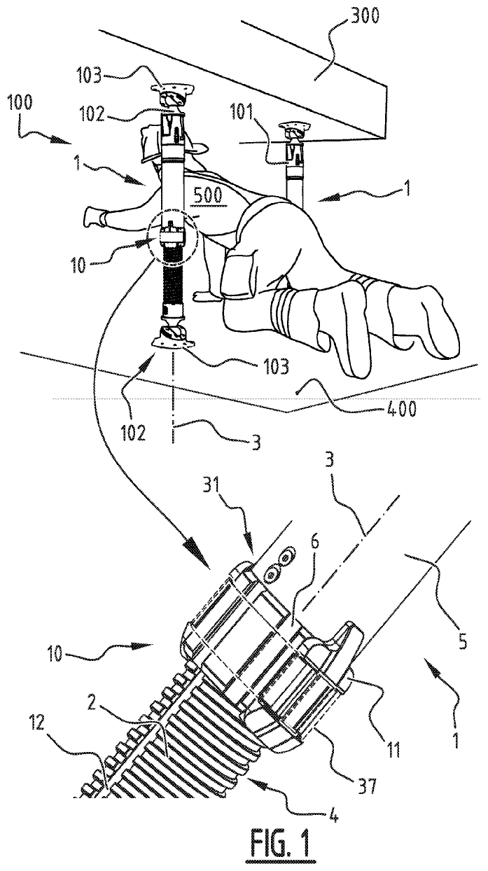

FIG. 1 shows a scene of a rescue worker using two struts for spot shoring, each strut being secured with a retaining arrangement;

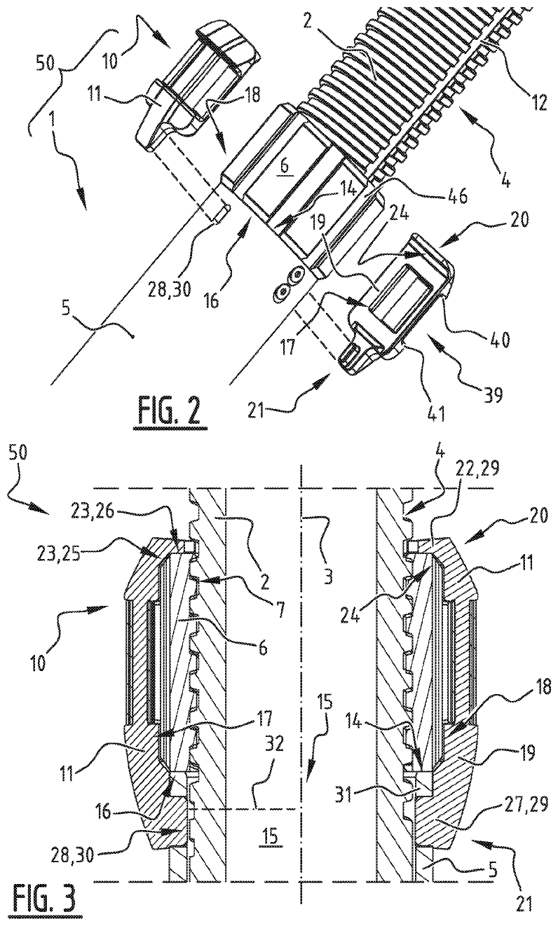

FIG. 2 shows a strut and an associated retainer arrangement in a releasing state;

FIG. 3 shows a cross-sectional view of the strut and the associated retainer arrangement of FIG. 2 in a retaining state;

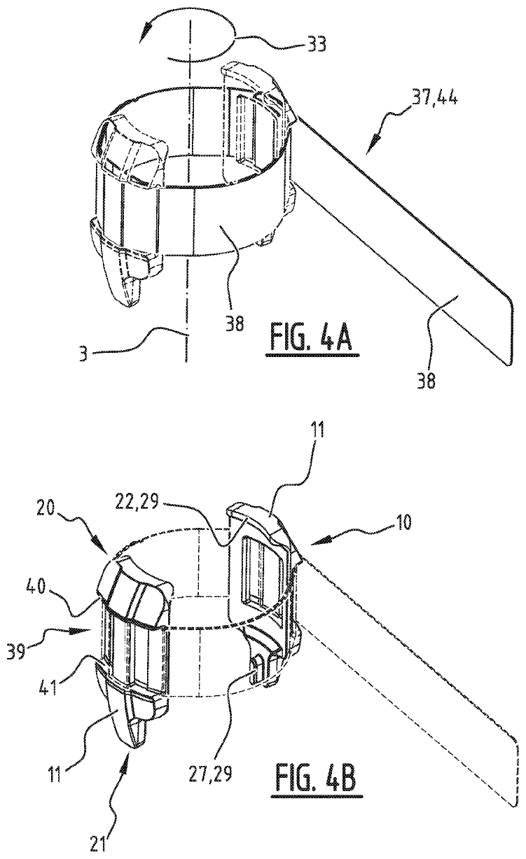

FIGS. 4A and 4B show a retainer arrangement and a flexible band arranged with it;

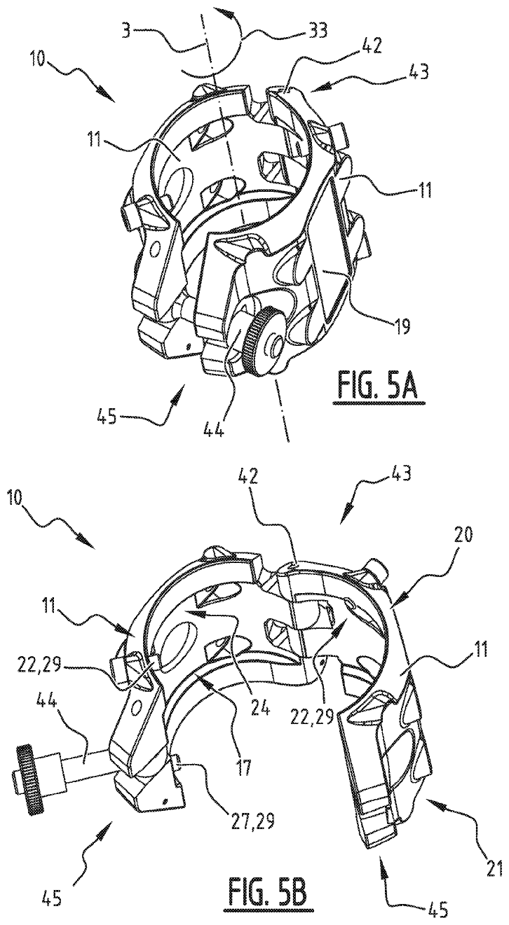

FIGS. 5A and 5B show a pivoting retaining arrangement in a closed and opened state, respectively;

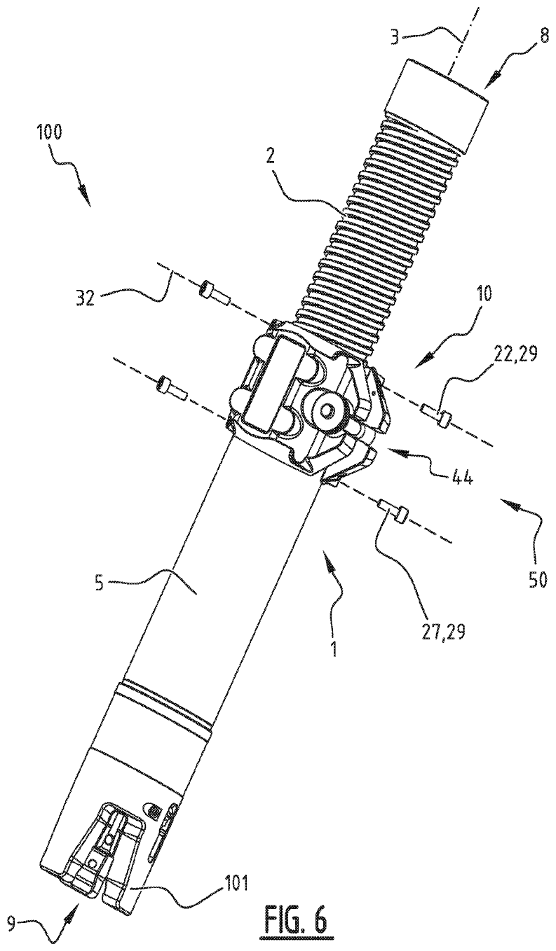

FIG. 6 shows the pivoting retaining arrangement of FIGS. 5A and 5B arranged on a strut;

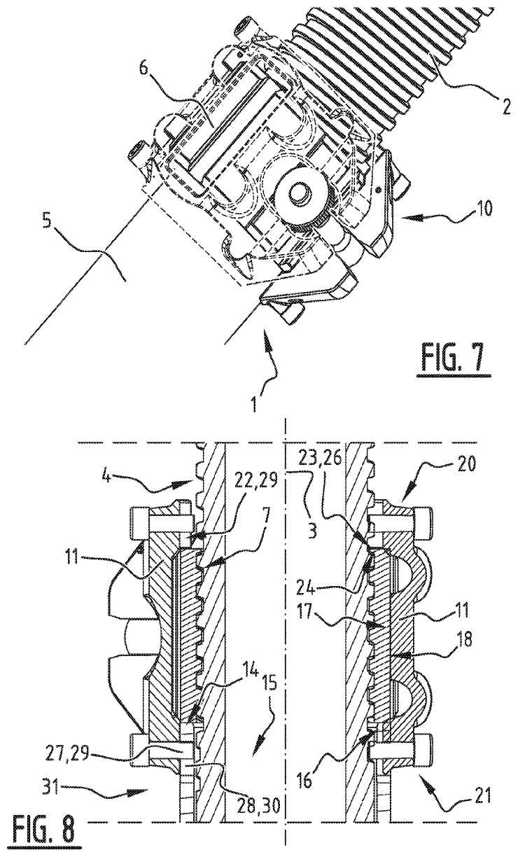

FIG. 7 shows a detailed view of FIG. 6;

FIG. 8 shows a cross-sectional view of FIG. 7;

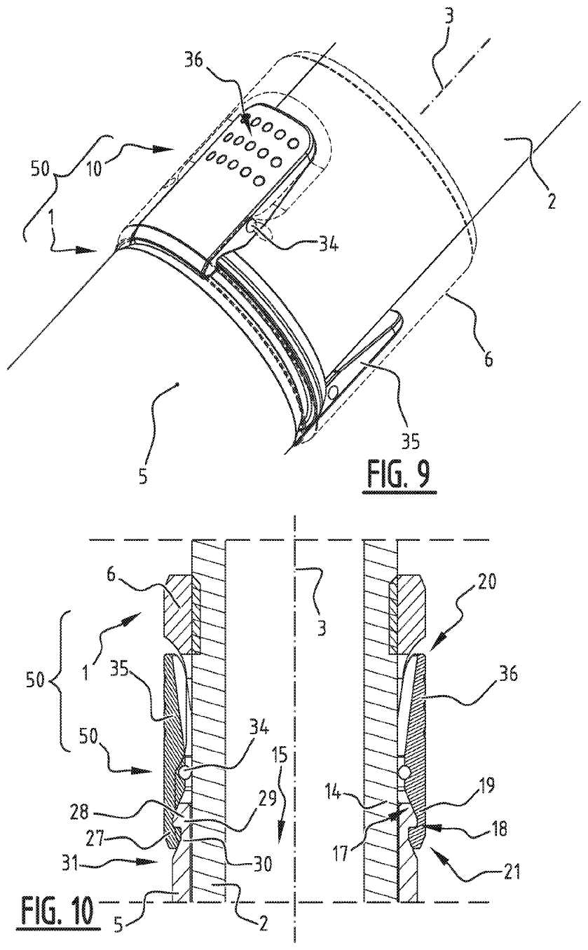

FIG. 9 shows a retaining arrangement pivotally coupled to a nut element of a strut and releasably coupled to an outer elongate member of said strut;

FIG. 10 shows a cross-sectional view of FIG. 9;

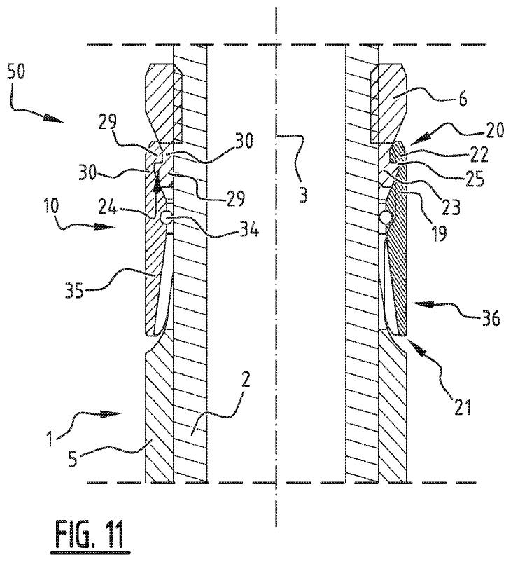

FIG. 11 shows a cross-sectional view of a retainer arrangement pivotally coupled to an outer elongate member of a strut and releasably coupled to a nut element of said strut;

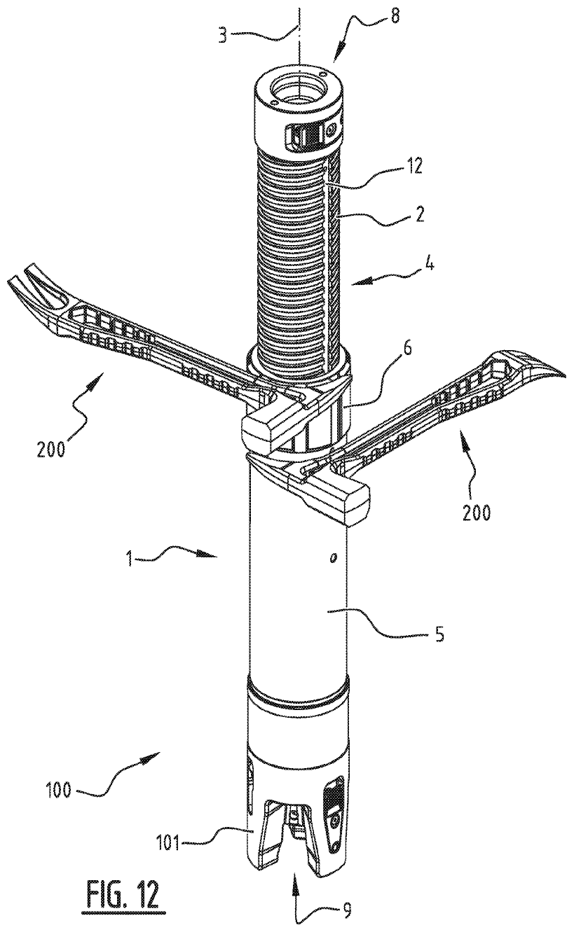

FIG. 12 shows how rescue tools can be used to tighten a nut element onto an outer elongate member of a length-adjustable strut;

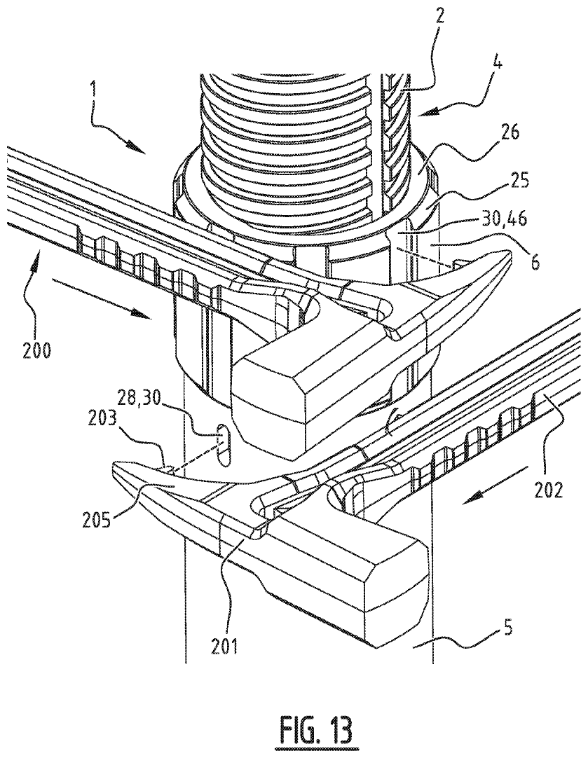

FIG. 13 shows a detailed view of FIG. 12 in which the rescue tools are released from the strut;

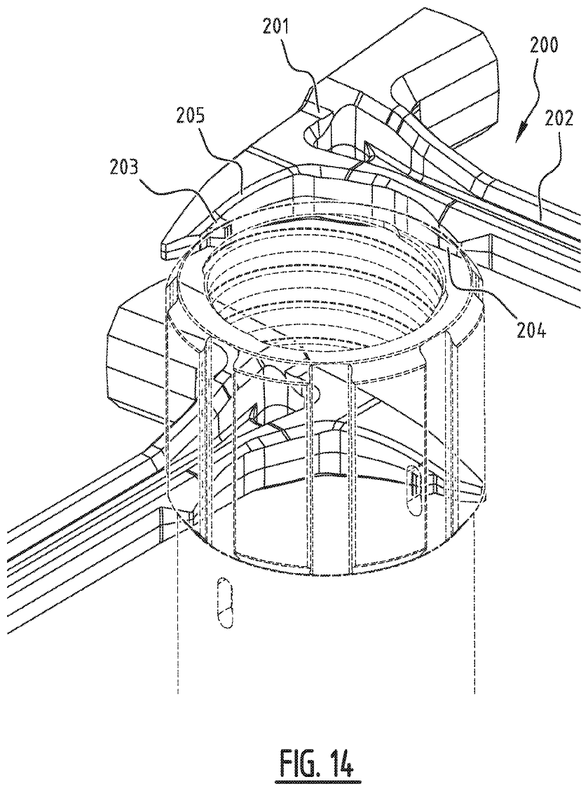

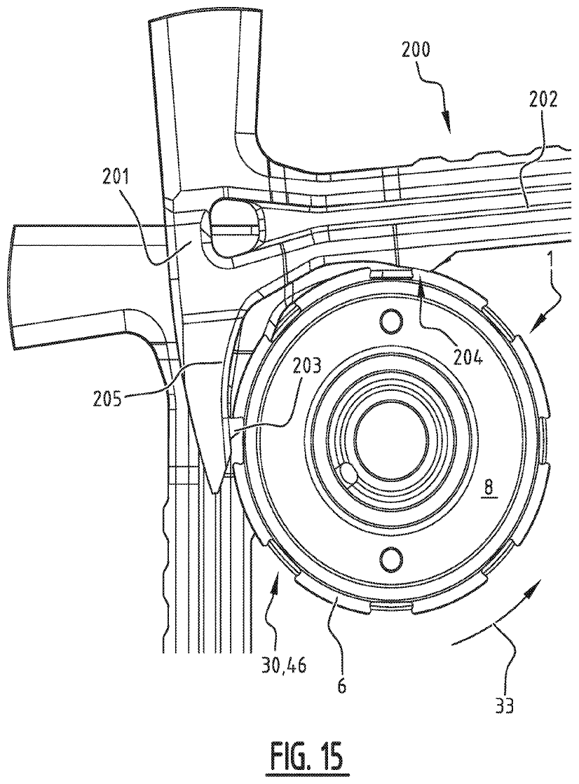

FIG. 14 shows the position of the rescue tools according to FIG. 12 in which these can engage the strut;

FIG. 15 shows a view onto the rescue tools and strut according to FIG. 12 from a first axial end of the strut;

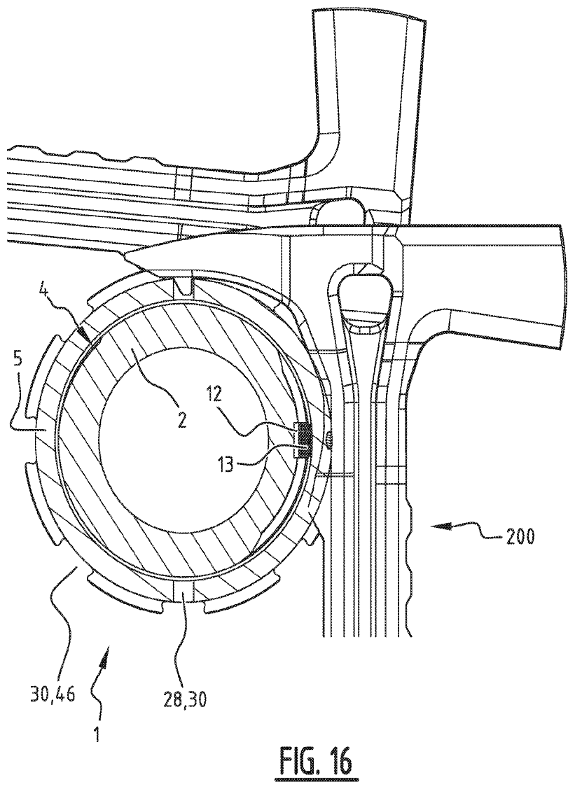

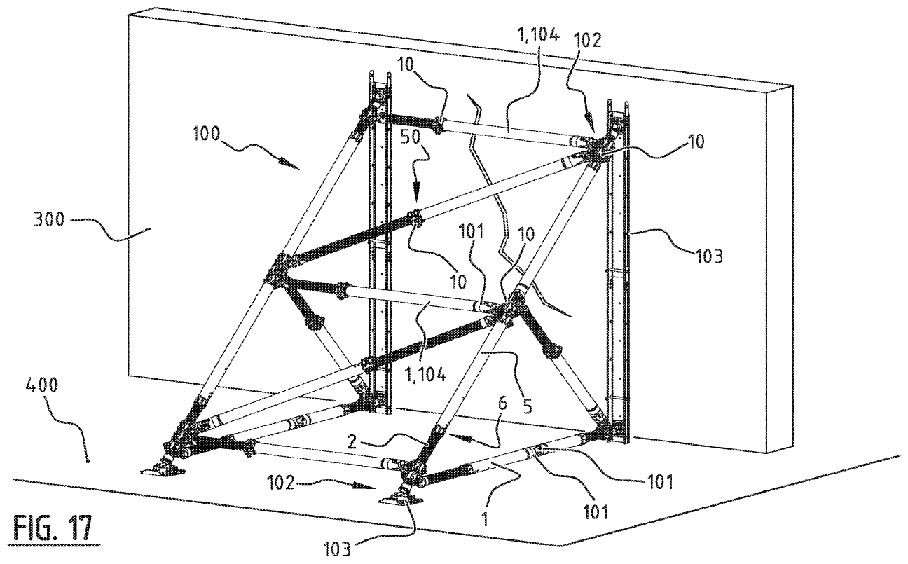

FIG. 16 shows a cross-sectional view onto the onto the rescue tools and strut according to FIG. 12 from a second axial end of the strut; and

FIG. 17 shows a raker construction in which struts and retainer arrangements are employed.

In FIG. 1, an unstable load 300 in the form of a slab is supported by a shoring construction comprising a strut 1 (two struts 1 are illustrated as an example) so that a rescue worker 500 can access a tight space under the unstable slab 300. The illustrated struts 1 are length adjustable. The strut 1 comprises an inner elongate member 2 extending in an axial direction 3 and having an outer thread 4. Further, the strut 1 comprises an outer elongate member 5 in which the inner elongate member 2 is slidably arranged so as to slide along the axial direction 3. The strut 1 is provide with a nut element 6 rotatably arranged over the inner elongate member 2 and provided with an inner thread 7 configured to engage the outer thread 4 of the inner elongate member 2.

The strut 1 is elongate along the axial direction 3 and comprises two ends 8, 9. A first axial end 8 of the strut 1 is located at a distal end of the inner elongate member 2 that is distant from the outer elongate member 5, while a second axial end 9 of the strut 1 is located at a distal end of the outer elongate member 5 that is distant from the inner elongate member 2. The first and second axial ends 8, 9 are on opposite end of the strut 1 and between them may define a length of the strut 1. By sliding the inner elongate member 2 inward or outward relative to the outer elongate member 5, the strut 1 can be adjusted in length be made shorter or longer, respectively. The strut 1 may be provided with an internal stop (not illustrated) which defines a maximum length of the strut 1 and which prevents the inner elongate member 2 from sliding completely out of the outer elongate member 5. A minimum length of the strut 1 is obtained when the inner elongate member 2 is slit into the outer elongate member 5 as far as possible, the nut element 6 being screwed as far as possible towards the first axial end 8. The minimum length of the strut 1 may be defined by a length of the outer elongate member 5, for example when the inner elongate member 2 can completely slide into the outer elongate member 5.

The strut 1 of FIGS. 1-3 is the same as illustrated in FIGS. 6-8. In FIGS. 9-11, the strut 1 is indicated schematically without much detail for simplicity (for example omitting the outer thread 4, the inner thread 7 and any guide elements 12, 13), though the same strut 1 may be used.

A retainer arrangement 10 is advantageously provided to prevent outward sliding of the inner elongate member 2 relative to the outer elongate member 5, in particular when the length of the strut 1 is below its maximum length.

The retainer arrangement 10 is adapted for the length-adjustable strut 1 and comprises at least one bracket 11 configured to releasably couple the nut element 6 and the outer elongate member 5 to prevent outward sliding of the inner elongate member 2 relative to the outer elongate member 5. As the inner thread 7 of the nut element 6 engages the outer thread 4 of the inner elongate member 2, when the bracket 11 couples the nut element 6 to the outer elongate member 5, it prevents outward sliding of the inner elongate member 2 along the axial direction 3 relative to the outer elongate member 5.

A detailed view of the illustrated scene is provided to better show the retainer arrangement 10 on the strut 1. This embodiment of the retainer arrangement 10 is further explained in relation to FIG. 2 to FIG. 4B. An alternative embodiment of the retainer arrangement 10 is presented in FIG. 5A to FIG. 8.

Though the illustrated embodiments have two brackets 11, only one bracket 11 may be sufficient to releasably couple the nut element 6 to the outer elongate member 5. Further, the retainer arrangement 10 may comprise at least two brackets 1. When two or more brackets 11 are employed, these may be distributed over a tangential direction 33 relative to the axial direction 3 of the strut 1 to engage the nut element 6 and/or outer elongate member 5 from various tangential positions, preferably on opposite sides of the strut 1. Such positioning balances forces and aids in preventing buckling of the strut 1.

Returning to the scene of FIG. 1, a connector 101 can be provided at the first and/or second axial ends 8, 9 of the strut 1. The connector 101 may be configured to couple an accessory 102 to the strut 1 and/or to couple to a further strut 1 having an identical connector 101 (e.g. as illustrated in FIG. 17). The connector 101 and/or the accessory 102 further define the shoring construction 100 which also comprises the strut 1. In the illustrated embodiments, the accessory 102 provides a support surface 103 to abut the unstable load 300 or to rest on the ground 400.

The nut element 6 and the outer elongate member 5 of the strut 1 are configured to be releasably coupled by the retainer arrangement 10 to prevent outward sliding of the inner elongate member relative to the outer elongate member. In other words, the strut 1 and the retainer arrangement 10 are correspondingly configured to form two interrelated products that can engage each other.

As illustrated here, the strut 1 is a rescue strut. A rescue strut is generally portable by rescue workers to be manually operable in tight spaces. Alternatively or additionally, the strut 1 and/or the retainer arrangement 10 form modular components for shoring or raker constructions 100.

The strut 1, in particular the outer elongate member 5 and the inner elongate member 2 thereof, comprises guides 12, 13 configured to guide sliding of the inner elongate member through the outer elongate member in the axial direction 3 and prevent rotation about the axial direction 3 (i.e. axial rotation of the inner elongate member 2 relative to the outer elongate member 3). In particular FIG. 1, FIG. 2 and FIG. 16 illustrate that the inner elongate member 2 can comprise a first guide element 12, while the outer elongate member 5 can comprise a corresponding second guide element 13. These first and second guide elements 12, 13 can be arranged along the axial direction 3 of the strut 1. The first guide element 12 may be inwardly recessed as seen in a radial direction 32 relative to the axial direction 3 and the second guide element 13 may be inwardly protruding as seen in the same radial direction 32 (this option is illustrated particularly clear in FIG. 16), or vice versa. Though when set of guides 12, 13 is illustrated, more than one guides 12, 13 may be provided, for example at different tangential positions along the tangential direction 33 relative to the axial direction 3 of the strut 1.

Outward sliding of the inner elongate member 2 relative to the outer elongate member 5 is limited by the position of the nut element 6. As the inner elongate member 2 slides inwardly into the outer elongate member 5, the nut element 6 will come to rest on the outer elongate member 5 and thereby prevent further inward sliding, i.e. shortening of the strut 1. When the nut element 6 is tightened over the outer thread 4 of the inner elongate member 2 onto the outer elongate member 5, it prevents inward sliding of the inner elongate member 2 relative to the outer elongate member 5.

The outer elongate member 5 of the strut 1 can comprise an abutment surface 14 facing the nut element 6 and surrounding an opening 15 (e.g. an insertion opening) through which the inner elongate member 2 is slidably arranged. The nut element 6 can comprise a bottom surface 16 facing the outer elongate member 5 to come to rest on the abutment surface 14 surrounding the opening 15 of the outer elongate member 5. The nut element 6 can be tightened onto the outer elongate member 5 to urge the inner elongate member 2 to slide out of the outer elongate member, for example to fine-adjust a length of the strut 1 when positioned to support an unstable load 300, preferably before the retainer arrangement 10 is applied.

The bracket 11 of the retainer arrangement 10 may further be configured to releasably couple the nut element 6 and the outer elongate member 5 to also prevent rotation of the nut element 5 over the inner elongate member 2.

The bracket 11 may engage or couple the nut element 6 and the outer elongate member 5 when the nut element 6 is abutting the outer elongate member 5. However, a spacing or interval may be present between these components, even when the retaining arrangement 10 is applied, for example as the retaining arrangement 10 bridges such space or interval.

The figures (e.g. in FIG. 1, 3, 6-11) illustrate in a retaining state in which the at least one bracket 11 of the retaining arrangement 10 is coupled to the nut element 6 and to the outer elongate member 5 and prevents outward sliding of the inner elongate member 2 relative to the outer elongate member 5, and preferably also prevents rotation of the nut element 6 over the inner elongate member 2. The nut element 6 may contact the outer elongate member 5 in the retaining state. Likewise, the nut element 6 and the outer elongate member 5 may correspondingly be configured to be releasably coupled by the retainer arrangement 10 to prevent rotation of the nut element 6 over the inner elongate member 5.

A releasing state is also shown (e.g. in FIGS. 2, 5B) in which the at least one bracket 11 of the retaining arrangement 10 is not coupled to (in other words, released from) at least one of the nut element 6 and the outer elongate member 5. In this state, outward sliding of the inner elongate member 2 relative to the outer elongate member 5 is allowed (i.e. not prevented), and preferably also rotation of the nut element 6 over the inner elongate member 2 is allowed. In the releasing state, the at least one bracket 11 of the retainer arrangement 10 may still be coupled to either the nut element 6 or to the outer elongate member 5, in particular in embodiments where the retainer arrangement 10 is coupled to or arranged on the other of the nut element 6 or the outer elongate member 5. Examples of such embodiments are shown in FIG. 9 to FIG. 11.

As particularly clear from FIGS. 3, 8, 10 and 11, the bracket 11 comprises an interior surface 17 shaped to engage an exterior surface portion 18 of the strut 1 comprising at least a portion of the nut element 6 and a portion of the outer elongate member 5. The exterior surface portion 18 may thus be defined by a portion or the whole of the nut element 6 in combination with a portion of the outer elongate member 5.

In particular, the at least one bracket 11 may be configured to embrace or extend over the nut element 6 along the axial direction. The bracket may comprise a bridge portion 19 extending in the axial direction 3, when arranged on the strut 1, between a first axial end 20 configured to engage the nut element 6 and a second axial end 21 configured to engage the outer elongate member 5.

Correspondingly, the exterior surface portion 18 of the strut 1 comprising at least the portion of the nut element 6 and the portion of the outer elongate member 5 can be shaped to engage the interior surface 17 of the bracket 10. In particular, the nut element 6 may be correspondingly configured to be embraced by the bracket 11 along the axial direction 3.

The illustrated brackets 11 comprise a first interior coupling element 22 configured to releasably engage a first exterior coupling element 23 of the nut element 6. The nut element 6 may thus correspondingly comprise the first exterior coupling element 23 configured to releasably engage the first interior coupling element 22 of the bracket 11. The interior and exterior coupling elements may take various forms. For example, the first interior coupling element 22 can comprises a protrusion 29 or recess 30 configured to releasably engage an associated recess 30 or protrusion 29, respectively, comprised by the first exterior coupling element 23.

In the illustrated embodiments, the first interior coupling element 22 comprises a protrusion 29 having an abutment surface 24 configured to engage an edge 25, in particular an upper edge, and/or top surface 26 of the nut element 6 which is distant from the outer elongate member 5 as seen along the axial direction 3. The bracket 11 may then embrace the nut element 6. The first exterior coupling element 23 of the nut element 6 may comprise the edge 25 and/or top surface 26 of the nut element 6 which is configured to engage the first interior coupling element 22 of the bracket 11. The protrusion 20 of the first interior coupling element 22 may span an arc segment in the tangential direction 33, for example between ⅛ to ½ of a full circle.

Alternatively, the first interior coupling element 22 of the bracket 11 can be formed as a protrusion 29 configured to engage a corresponding recess 30 in the nut element 6 formed by the first exterior coupling element 23 of the nut element 6. The strut 1 may be formed correspondingly, in that the first exterior coupling element 23 comprises a recess 30 or protrusion 29 configured to releasably engage an associated protrusion 29 or recess 29, respectively, comprised by the first interior coupling element 22.

Alternatively or in addition to the first interior and exterior coupling elements 22, 23, the bracket 11 and the strut 1 can be releasably coupled by second interior and exterior coupling elements 27, 28. The bracket 11 comprises the second interior coupling element 27 configured to releasably engage the second exterior coupling element 28 of the outer elongate member 5. Correspondingly, the outer elongate member 5 of the strut 1 comprises the second exterior coupling element 28 configured to releasably engage the second interior coupling 27 of the bracket 11.

In the illustrated embodiments, the second interior and exterior coupling elements 27, 28 are formed by a protrusion 29 arranged at the second axial end 9 of the bracket 11 and by a corresponding recess 30 in the outer elongate member 5, respectively. Said protrusion 29 and recess 30 are arranged radially inwardly into the strut 1, seen in a radial direction 32 relative to the axial direction 3. Further, the protrusion 29 is elongate in the axial direction 3 and the recess 30 is likewise formed elongate in the axial direction 3, thus forming a slit.

In general, the second interior coupling element 27 may comprise a protrusion 29 or recess 30 configured to releasably engage an associated recess 30 or protrusion 29, respectively, comprised by the second exterior coupling element 28. Correspondingly, the second exterior coupling element 28 of the outer elongate member 5 comprises a protrusion 29 or recess 30 configured to releasably engage an associated recess 30 or protrusion 29, respectively, comprised by the second interior coupling element 27 of the bracket 11.

The second exterior coupling element is arranged at or near an axial end 31 of the outer elongate member 5 into which the inner elongate member is slidably arranged. This axial end 31 is the end of the outer elongate member that is opposite the second axial end 9 of the strut 1. Said axial end 31 may be therefore be referred to as the inner axial end 31 of the outer elongate member 5. The axial end 31 may be defined by the abutment surface 14 of the outer elongate member 5.

The interior surface 17 of the bracket 11 may comprises either or both of the first interior coupling element 22 and the second interior coupling element 27. The retainer arrangements 10 of FIGS. 1 to 8 have both the first and second interior coupling elements 22, 27 while the retainer arrangement 10 of FIGS. 9-10 only has the second interior coupling element 27 and the retainer arrangement of FIG. 11 has only the first interior coupling element 22.

In any case, the first interior coupling element 22 may be arranged at the first axial end 20 of the bracket 11 configured to be releasably coupled to the nut element 6 and/or the second interior coupling element 27 may be arranged at the second axial end 21 of the bracket 11 configured to be releasably coupled to the outer elongate member 5.

In FIGS. 1 to 4B, the first interior coupling element 22 of the bracket 11 is a protrusion 29 with the first exterior coupling element 23 of the nut element 6 is formed by the edge 25 and the top surface 26 of the nut element 6. The second interior coupling element 27 is an elongate protrusion 29 corresponding to an elongate recess 30 (or slit) in the outer elongate member 5 arranged towards the axial end 31 thereof.

In FIGS. 5A to 8, the first and second interior coupling elements 22, 27 of the bracket 11 are formed as protrusions 29 (in the form of pins) configured to engage with a corresponding edge 25 of the nut element 6 and a recess 30 of the outer elongate member 5, respectively.

In FIGS. 9 and 10, the bracket 11 comprises the second interior coupling element 27 to engage the second exterior coupling element 28 of the outer elongate member 5. The second interior coupling element 27 is a protrusion 29 in the form of a hook configured to engage a recess 30 of the second exterior coupling element 28 in the form of an edge or flange near the inner axial end 31 of the outer elongate member 5.

In FIG. 11, the bracket 11 comprises the first interior coupling element 22 to engage the first exterior coupling element 23 of the nut element 6. The first interior coupling element 22 is a protrusion 29 in the form of a hook configured to engage a recess 30 of the first exterior coupling element 23 in the form of an edge or flange arranged near the bottom surface 16 of the nut element 6.

In general, the bracket 11 may comprise one of the first interior coupling element 22 and the second interior coupling element 27 configured to releasably engage one of the nut element 6 and the outer elongate member 5, respectively; and a pivot 34 couplable to the other of the nut element 6 and the outer elongate member 5. In particular, the pivot 34 can be coupled to or be fixedly arranged with the other of the nut element 6 and the outer elongate member 5.

The bracket 11 of the retainer arrangements of FIGS. 9 to 11 comprises a biased lever 35 that is pivotably coupled (or, when provided separately, couplable to) one of the nut element 6 and the outer elongate member 5 and releasably couplable to the other of the nut element 6 and the outer elongate member 5. The illustrate lever 35 has a push surface 36 for pressing the bracket 11 at its first or second axial end 20, 21 so as to release the second or first interior coupling element arranged at the second or first axial end 21, 20 of the bracket, respectively, from the associated second or first exterior coupling element 28, 23 of the strut 1. The lever 35 may be biased to urge engagement of coupling elements, as shown in the figure, though it may alternatively urge disengagement thereof. An additional means for clamping can be provided, for example as explained below.

This retainer arrangement 10 of FIGS. 9 to 11 may be provided as part of a length-adjustable strut 1, or at least with the nut element 6 or the outer elongate member 5 thereof. Additional means for coupling the retainer arrangement 10 to the strut 1 may then be superfluous. Such fixedly coupled retainer arrangement 10 may always couple the nut element 6 to the outer elongate member 5 when brought in the correct relative position. This may be advantageous is many use cases, though a separate retainer arrangement 10 (such as illustrated in FIGS. 1 to 8) may provide advantageous versatility.

Especially when the retainer arrangement 10 is provided separately from the strut 1, means for clamping the retainer arrangement 10 the strut 1 may be desirable. Two variations are illustrated.

FIGS. 1 to 4B show a flexible band 37 for releasably coupling one or more than one bracket 11 to the strut 1, in particular to the nut element 6 and/or the outer elongate member 5 of the strut 1. The flexible band 37 may comprise a releasable band fastener 38, such as in the form of a hook-and-loop fastener.

The bracket may comprise a band guide slot 39 configured to guide the flexible band 37 in the tangential direction 33 relative to the axial direction 3 around the bracket 11 for fastening one or more than one bracket 11 to the strut 1. When the flexible band 37 is fastened, it can force itself in the band guide slot 39.

The band guide slot 39 can comprise an upper rim 40 and a lower rim 41 extending in the tangential direction 33 that are configured to guide the flexible band 37 therebetween and prevent the flexible band 37 from sliding away along the axial direction 3, thereby potentially releasing the bracket(s) 11 from the strut 1.

The flexible band 37 can be used to join multiple brackets 11 in one retaining arrangement 10. Two are illustrated as this as a convenient number to be installed by an individual rescue worker 400 using both hands. A first bracket 11 may be connected to the flexible band 37 at a first end of the flexible band 37 with the second bracket 11 being connected at an appropriate distance along the flexible band 37 to be arranged on the strut 1 opposite the first bracket 11. The second end of the flexible band 37 may then protrude beyond the second bracket 11 to surround the strut 1 at least once and connect onto itself, e.g. by means of the releasable fastener 38.

FIGS. 5A to 7 show a retainer arrangement 10 with two brackets that are connected my means of a pivot 42. The pivot 42 is arranged at a first tangential end 43 of the brackets 11. A closure device 44 is provided in the form of bolt and nut arrangement to releasably couple the two brackets at a second tangential end 45, opposite the first tangential end 43 at which the pivot 42 is arranged. The closure device 44 cold also be implemented as a flexible band 37 described above. When this retainer arrangement 10 is coupled to the strut 1, the pivot is positioned at a first tangential position relative to the axial direction 3 of the strut 1 while the closure device 44 is arranged at a second tangential position, here opposite the first tangential position.

FIG. 5A shows a closed or retaining state of the retainer arrangement 10, while FIG. 5B shows an opened or releasing state of the retainer arrangement 10.

FIG. 6 shows a shoring construction 100 comprising a length-adjustable strut 1 and the retainer arrangement 10 of FIG. 5A-5B. The connector 101 arranged at the second axial end 9 of the strut 1 is shown in more detail. Further, the protrusions 29 of the first and second interior coupling elements 22, 27 of the brackets 11 are illustrated as releasable pins, for example as bolts of which the position can be adjusted along the radial direction 32.

FIGS. 1-3, 6-11 and 17 show various strut assemblies 50. A strut assembly 50 may comprise a length-adjustable strut 1 and a retainer arrangement 10 arranged or arrangeable on the strut 1. The retainer arrangement 10 can be provided separately from the strut 1, for example as illustrated in FIG. 1 to FIG. 8, to be completely decoupled from the strut 1. Alternatively, the retainer arrangement 10 can already be arranged on the strut 1, for example by being arranged on the nut element 6 (e.g. FIGS. 9 and 10) or on the outer elongate member 5 (FIG. 11).

A strut assembly 50 can therefore be provided, comprising the length-adjustable strut 1 as disclosed herein in combination with a retainer arrangement 10 as disclosed herein, wherein the retainer arrangement 10 is arranged on the strut 1 or is arrangeable on the strut 1. In other words, the retainer arrangement 10 may be configured couplable to the strut 1, to provide a strut assembly 50 with separate retainer arrangement 10 and strut 1, or may be configured coupled to the strut 1 to provide a strut assembly 50 with fixedly coupled retainer arrangement 10 and strut 1.

According to the various illustrated embodiments, the strut assembly 50 is configured to, in a retaining state in which the at least one bracket 11 of the retainer arrangement 10 is coupled to the nut element 6 and to the outer elongate member 5, prevent outward sliding of the inner elongate member 2 relative to the outer elongate member 5 and may even prevent rotation of the nut element 6 over the inner elongate member 2, and is further configured to, in a releasing state in which the at least one bracket 11 is not coupled to at least one of the nut element 6 and the outer elongate member 5, allow outward sliding of the inner elongate member 2 relative to the outer elongate member 5 and may even prevent rotation of the nut element 6 over the inner elongate member 2.

FIGS. 12 to 16 illustrate an advantageous further configuration and use of the first and/or second exterior coupling elements 23, 28 of the strut 1. As shown in these figures, the second exterior coupling element 28 is configured to receive a tool 200, here shown as a rescue tool, for holding the outer elongate member 5 when turning the nut element 6. Moreover, even the nut element 6 may be configured to receive or engage a similar tool 200. The first exterior coupling element 23 of the nut element 6 may comprise recesses 30, illustrated as grooves 46 over its exterior surface, in particular along the axial direction 3.

Th rescue tool 200 presents a wrench function adapted for the strut 1. Two such tools 200 may be used, one to engage the nut element 6 and another to engage the outer elongate member 5. The nut element 6 can be rotated over the inner elongate member 2 onto or away from the outer elongate member 5 to pretension or release the connection between these components.

The recue tool 200 comprises a head 201 and a handle 202. The head 201 is at least in part formed by a curved section 205 of the tool 200 transversely extending from the handle 202. The head 201 is provided with a protrusion 203 configured to engage the recess 30 of the second exterior coupling element 28 of the outer elongate member as well the recess 30 or groove 46 arranged on the nut element 6. The curved section 205 extends transversely from the handle 202 so that the tool 200 can be used to provide torque along the tangential direction 33 when the protrusion 203 engages said recess 30 or groove 46.

An abutment 204 is also provided, preferably on the handle 202, to contact the nut element 6 or the outer elongate element 5 at a different tangential position. The abutment 204 defines a pivot for applying torque with the tool 200. The tangential positions at which the protrusion 203 and the abutment 204 engage the strut 1 are separated, preferably by about ¼ of a full circle.

FIG. 13 shows that the tool 200 can engage and disengage the recess 30 or groove 46 on the nut element 6 and the recess 30 on the outer elongate member 5 in the direction of the arrows. Once engaged, force is applied to the handle 201 of the tool 200 in the tangential direction 33 so that the protrusion 203 pulls on the nut element 6 or the outer elongate member 5 through its recess 30.

In FIG. 17, a shoring construction 100 is illustrated in the form of a raker construction. The raker construction 100 comprises one or more than one length-adjustable strut 1. Retainer arrangements 10 are arranged on those length-adjustable struts 1 which serve as braces 104 in the raker construction 100 to prevent outward sliding of the inner elongate member 2 relative to the outer elongate member 5 (i.e. prevent elongation of those struts 1 acting as the braces 104). The remaining struts 1 function as conventional struts for which elongation is less problematic.

In the illustration, retainer arrangements 10 according to FIGS. 5A to 8 are employed as an example only. Various strut assemblies 50 are employed in the illustrated raker construction 100.

The retainer arrangement 10 may further be configured to couple to the first and/or second axial ends 8, 9 of the strut 1, for example via a connector 101 or an accessory 102. As shown in FIG. 17, the retainer arrangement 10 is configured to clamp the outer thread 4 of the inner elongate member 2, a connector 101 or the outer elongate member 5. The retaining arrangement 10 as disclosed herein thus provides a versatile construction component for shoring applications.

Though the retainer arrangement 10 is illustrated with protrusions 29 and the strut 1 with recesses 30, the implementation of the coupling elements may be reversed or combined. For example, the outer elongate member 5 may comprise the second exterior coupling element 28 in the form of one or more protrusions 29 while the second interior coupling element 27 of the bracket 11 may be provided in the form of one or more associated recesses 30. The same variation is possible for the first interior and exterior coupling elements 22, 23.

Use of the length-adjustable strut 1 in combination with the retainer arrangement 10 may involve supporting an unstable load 300, for example in shoring applications or rescue operations (e.g. as illustrated in FIG. 1 and FIG. 17), and may involve assembling a strut assembly 50 and/or a shoring construction 100.

A method of shoring may comprise the following steps, preferably in this order:
a length-adjustable strut 1 and a retainer arrangement 10 as disclosed herein are provided.
a length of the length-adjustable strut 1 is adjusted based on a desired spacing. This is performed by sliding the inner elongate member 2 relative to the outer elongate member 5 in the axial direction 3 of the length-adjustable strut 1. The length may vary between the minimum length and the maximum length of the length-adjustable strut 1, which may be selected in accordance with the space to be bridged for the particular application at hand. This step may involve positioning of the length-adjustable strut 1 to support the unstable load 300.
The nut element 6 is tightened onto the outer elongate member 5 to prevent inward sliding of the inner elongate member 2 relative to the outer elongate member 5. The nut element 6 may then contact the outer elongate member 5 to provide a mechanical stop to said inward sliding. The tightening can comprise use of the rescue tool 200 as explained in relation to FIG. 12 to FIG. 16. During this step, the unstable load 300 may become supported by the length-adjustable strut 1.
The retainer arrangement 10 is coupled to both the nut element 6 and the outer elongate member 5 of the length-adjustable strut 1 to prevent outward sliding of the inner elongate member 2 relative to the outer elongate member 5. This may also prevent rotation of the nut element 6 over the inner elongate member 2.
The flexible band 37 and/or the closure device 44 may be closed around the retainer arrangement 10 to further fasten it to the length-adjustable strut 1.

Depending on the use case, the length-adjustable strut 1 may be positioned to support the unstable load 300 at various moments, for example during or after any of the step of adjusting the length of the length-adjustable strut 1, tightening the nut element 6 thereof, or coupling the retainer arrangement 10 thereto.

The above steps can be followed in reverse order when the application is concluded and the length-adjustable strut 1 or strut assembly are to be removed from the unstable load 300.

1. A retainer arrangement adapted for a length-adjustable strut having an inner elongate member extending in an axial direction and having an outer thread, an outer elongate member in which the inner elongate member is slidably arranged to slide along the axial direction, and a nut element rotatably arranged over the inner elongate member and provided with an inner thread configured to engage the outer thread of the inner elongate member, the retainer arrangement comprising:
at least one bracket configured to releasably couple the nut element and the outer elongate member to prevent outward sliding of the inner elongate member relative to the outer elongate member,
wherein at least one of:
the retainer arrangement further comprises a flexible band configured to releasably couple the at least one bracket to one or more of the nut element and the outer elongate member of the strut, and
the at least one bracket comprises a band guide slot configured to guide a flexible band in a tangential direction relative to the axial direction around the bracket for fastening the at least one bracket to the strut.

2. The retainer arrangement of claim 1, wherein the at least one bracket is further configured to at least one of:
releasably couple the nut element and the outer elongate member to prevent rotation of the nut element over the inner elongate member, and
embrace the nut element along the axial direction.

3. The retainer arrangement of claim 1 configured to:
in a retaining state in which the at least one bracket is coupled to the nut element and to the outer elongate member, prevent outward sliding of the inner elongate member relative to the outer elongate member and prevent rotation of the nut element over the inner elongate member; and
in a releasing state in which the at least one bracket is not coupled to at least one of the nut element and the outer elongate member, allow outward sliding of the inner elongate member relative to the outer elongate member and allow rotation of the nut element over the inner elongate member.

4. (canceled)

5. (canceled)

6. The retainer arrangement of claim 1, wherein the at least one bracket comprises a first interior coupling element configured to releasably engage a first exterior coupling element of the nut element, and
wherein the first interior coupling element comprises a protrusion or recess configured to releasably engage an associated recess or protrusion, respectively, comprised by the first exterior coupling element.

7. (canceled)

8. The retainer arrangement of claim 6, wherein the first interior coupling element comprises a protrusion having an abutment surface configured to engage one or more of an edge and a top surface of the nut element distant from the outer elongate member along the axial direction.

9. The retainer arrangement of claim 6, wherein the at least one bracket comprises a second interior coupling element configured to releasably engage a second exterior coupling element of the outer elongate member,
wherein the second interior coupling element comprises a protrusion or recess configured to releasably engage an associated recess or protrusion, respectively, comprised by the second exterior coupling element.

10. (canceled)

11. The retainer arrangement of claim 9, wherein the at least one bracket comprises a first interior coupling element configured to releasably engage a first exterior coupling element of the nut element, and
wherein the interior surface of the at least one bracket comprises the first interior coupling element and the second interior coupling element.

12. The retainer arrangement of claim 11, wherein the at least one bracket comprises:
the first interior coupling element arranged at a first axial end of the bracket configured to be releasably coupled to the nut element, and
the second interior coupling element arranged at a second axial end of the bracket configured to be releasably coupled to the outer elongate member.

13. The retainer arrangement of claim 1, wherein the at least one bracket comprises the band guide slot,
wherein the band guide slot comprises an upper rim and a lower rim extending in the tangential direction configured to guide the flexible band therebetween.

14. (canceled)

15. The retainer arrangement of claim 1, further comprising the flexible band that comprises one of a releasable band fastener and a hook-and-loop fastener.

16. (canceled)

17. The retainer arrangement of claim 1, wherein the at least one bracket comprises two brackets and a pivot connecting the two brackets at a first tangential position with a closure device to releasably couple the two brackets at a second tangential position.

18. (canceled)

19. (canceled)

20. The retainer arrangement of claim 9, wherein the at least one bracket comprises:
one of the first interior coupling element and the second interior coupling element configured to releasably engage one of the nut element and the outer elongate member, respectively, and
a pivot couplable to the other of the nut element and the outer elongate member.

21. The retainer arrangement of claim 1, wherein the at least one bracket comprises a biased lever pivotably couplable to one of the nut element and the outer elongate member and releasably couplable to the other of the nut element and the outer elongate member.

22. A strut assembly comprising:
the retainer arrangement of claim 1, and
a length-adjustable strut having an inner elongate member extending in an axial direction and having an outer thread, an outer elongate member in which the inner elongate member is slidably arranged to slide along the axial direction, and a nut element rotatably arranged over the inner elongate member and provided with an inner thread configured to engage the outer thread of the inner elongate member,
wherein the nut element and the outer elongate member are configured to be releasably coupled by the retainer arrangement to prevent outward sliding of the inner elongate member relative to the outer elongate member, and
wherein the retainer arrangement is arranged or arrangeable on the strut.

23. The strut assembly of claim 22, wherein the strut assembly is configured to:
in a retaining state in which the at least one bracket is coupled to the nut element and to the outer elongate member, prevent outward sliding of the inner elongate member relative to the outer elongate member and prevent rotation of the nut element over the inner elongate member, and
in a releasing state in which the at least one bracket is not coupled to at least one of the nut element and the outer elongate member, allow outward sliding of the inner elongate member relative to the outer elongate member and allow rotation of the nut element over the inner elongate member.

24. (canceled)

25. The strut assembly of claim 22, wherein at least one of:
the nut element and the outer elongate member are configured to be releasably coupled by the retainer arrangement to prevent rotation of the nut element over the inner elongate member,
an exterior surface portion of the strut comprising at least a portion of the nut element and a portion of the outer elongate member are shaped to engage an interior surface of the at least one bracket, and
the nut element is configured to be embraced by the at least one bracket along the axial direction.

26. The strut assembly of claim 22, wherein the nut element comprises a first exterior coupling element configured to releasably engage a first interior coupling element of the at least one bracket, and
wherein at least one of:
the first exterior coupling element comprises a recess or protrusion configured to releasably engage an associated protrusion or recess, respectively, comprised by the first interior coupling element, and
the first exterior coupling element comprises one or more of an edge and a top surface of the nut element distant from the outer elongate member along the axial direction configured to engage the first interior coupling element comprising a protrusion having an abutment surface configured to engage one or more of the edge and the top surface of the nut element.

27. (canceled)

28. The strut assembly of claim 26, wherein the outer elongate member comprises a second exterior coupling element configured to releasably engage a second interior coupling of the at least one bracket, and
wherein the second exterior coupling element comprises a protrusion or recess configured to releasably engage an associated recess or protrusion, respectively, comprised by the second interior coupling element.

29. (canceled)

30. The strut assembly of claim 28, wherein the second exterior coupling element is one or more of: (i) arranged at or near an axial end of the outer elongate member into which the inner elongate member is slidably arranged, and (ii) configured to receive a tool to hold the outer elongate member when turning the nut element.

31. (canceled)

32. The strut assembly of claim 22, wherein at least one of:
(i) the strut is configured to prevent inward sliding of the inner elongate member relative to the outer elongate member when the nut element is tightened over the outer thread of the inner elongate member onto the outer elongate member,
(ii) the outer elongate member comprises an abutment surface facing the nut element and surrounding an opening through which the inner elongate member is slidably arranged,
(iii) the outer elongate member and the inner elongate member comprise guides configured to guide sliding of the inner elongate member through the outer elongate member in the axial direction and prevent rotation about the axial direction.

33. (canceled)

34. (canceled)

35. A shoring or raker construction comprising:
at least one strut assembly according to claim 22.

36. A method of shoring using the strut assembly of claim 22, the method comprising of:
adjusting a length of the length-adjustable strut based on a desired spacing by sliding the inner elongate member relative to the outer elongate member in the axial direction of the length-adjustable strut;
tightening the nut element onto the outer elongate member to prevent inward sliding of the inner elongate member relative to the outer elongate member; and
coupling the retainer arrangement to both the nut element and the outer elongate member of the length-adjustable strut to prevent outward sliding of the inner elongate member relative to the outer elongate member and optionally prevent rotation of the nut element over the inner elongate member.

37. (canceled)
